(19) United States
(12) Patent Application Publication
(10) Pub. No.: US 2025/0207921 A1
(43) Pub. Date: Jun. 26, 2025

(54) Method for Altering the Destination As a User Proceeds on a Route

(71) Applicant: GOOGLE LLC, Mountain View, CA (US)

(72) Inventor: Matthew Sharifi, Mountain View, CA (US)

(21) Appl. No.: 18/396,369

(22) Filed: Dec. 26, 2023

(51) Int. Cl. G01C 21/34

(52) U.S. Cl. CPC G01C 21/3415; G01C 21/3476

(57) ABSTRACT

To alter a destination during a navigation session, a computing device receives a geographic query, and identifies a set of points of interest (POIs) responsive to the geographic query. One of the set of POIs is selected as an active destination for a user. The computing device stores one or more other POIs in the set as alternative destinations. Then during a navigation session as a user begins traveling, the computing device provides a first set of navigation directions for navigating to the active destination. Prior to reaching the active destination, the computing device provides at least a second set of navigation directions for navigating from a current location of the user to at least one of the alternative destinations.

### FIELD OF THE DISCLOSURE

The present disclosure generally relates to navigation systems and more particularly, to adjusting a user's destination on the fly as the user proceeds along a route, for example when multiple destinations have similar properties.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications executing in computers, smartphones, embedded devices, etc., generate step-by-step navigation directions in response to receiving input from a user, specifying the starting point and the destination. The navigation directions are typically generated for a route which guides the user to the destination in the shortest amount of time.

Additionally, software applications can update routes in real-time based on changes in circumstances, such as increased traffic on the route, or the user taking a wrong turn or traveling off the original route. However, these software applications generally re-route the user to the original destination. This can be inefficient when there are other similar destinations that can be reached more efficiently from the user's current location.

### SUMMARY

To adjust the active destination as a user proceeds along a route, a navigation system receives a geographic query from a user. The navigation system generates a set of search results responsive to the geographic query, where each search result is a candidate destination. When the user selects one of the candidate destinations as the active destination for navigation, the navigation system generates navigation directions along a route to the active destination and begins a navigation session. Additionally, the navigation system stores the remaining candidate destinations as alternative destinations.

Then as the user proceeds along the route, the navigation system may provide alternative directions to at least one of the alternative destinations as the navigation system provides navigation directions to the active destination. Additionally or alternatively, the navigation system may periodically or continuously compare the route to the active destination to routes to the alternative destinations. If a route to an alternative destination is faster than the route to the original destination, the navigation system may provide a recommendation for the user to switch to the alternative destination. The recommendation to switch to the alternative destination may be particularly beneficial in the case where, for example, the user has not conformed to the original route. Such non-conformance may be due to road conditions (traffic, closed roads, diversions, etc.) or user error such as missing a turning presented by the navigation directions. Due to the non-conformance, the original destination (a POI of a certain category) may no longer be the closest destination of that same category, and therefore the navigation system determines the new closest destination of that same category as a recommended alternative destination. Alternatively, instead of being a closer destination, the alternative destination may provide a faster arrival time or a more fuel-efficient route, for example. As such, the navigation system beneficially determines, in response to a user failing to follow an original route to an original destination of a certain category, a new route to an alternative destination of the same category which is now more efficient than travelling to the original destination in terms of distance, time, fuel or another metric.

Still further, when the user makes a maneuver, the navigation system may determine whether to remove one of the alternative destinations. For example, if the route to the original destination requires a right turn at a particular intersection, the route to an alternative destination requires a left turn at the particular intersection, and the user turns right, the navigation system may remove the alternative destination from a set of alternative destinations. On the other hand, if the user turns left, the navigation system may determine that the alternative destination is the active destination and may begin providing navigation directions to the alternative destination instead of the active destination.

The navigation system described herein is thus able to not only adjust the route as the user is traveling based on real-time information, but also to adjust the destination to improve navigation efficiency. In this manner, the navigation system saves the user time and resources (e.g., fuel, power, etc.) and gives the user more options when navigating. The navigation system also allows the user to browse search results while they are en route rather than having to look through them and select one as the destination before the navigation session begins. Additionally, the navigation system addresses safety concerns because the user does not need to manually enter additional information when they want to change the destination to another similar destination. Instead, the user can simply begin navigating in the direction of the similar destination and the navigation system adjusts accordingly.

One example embodiment of the techniques of this disclosure is a method for altering a destination during a navigation session. The method includes receiving a geographic query, and identifying a set of points of interest (POIs) responsive to the geographic query. One of the set of POIs is selected as an active destination for a user. The method also includes storing one or more other POIs in the set as alternative destinations. During a navigation session as a user begins traveling, the method includes providing a first set of navigation directions for navigating to the active destination. Prior to reaching the active destination, the method includes providing at least a second set of navigation directions for navigating from a current location of the user to at least one of the alternative destinations.

Another example embodiment is a computing device for altering a destination during a navigation session. The computing device includes one or more processors and a computer-readable memory, which is optionally non-transitory, coupled to the one or more processors and storing instructions thereon. The instructions, when executed by the one or more processors, cause the computing device to receive a geographic query and identify a set of points of interest (POIs) responsive to the geographic query. One of the set of POIs is selected as an active destination for a user. The instructions also cause the computing device to store one or more other POIs in the set as alternative destinations. During a navigation session as a user begins traveling, the instructions cause the computing device to provide a first set of navigation directions for navigating to the active destination. Prior to reaching the active destination, the instructions cause the computing device to provide at least a second set of navigation directions for navigating from a current location of the user to at least one of the alternative destinations.

Yet another example embodiment is a computer-readable medium, which is optionally non-transitory, storing instructions, that when executed by one or more processors cause the one or more processors to receive a geographic query and identify a set of points of interest (POIs) responsive to the geographic query. One of the set of POIs is selected as an active destination for a user. The instructions also cause the one or more processors to store one or more other POIs in the set as alternative destinations. During a navigation session as a user begins traveling, the instructions cause the one or more processors to provide a first set of navigation directions for navigating to the active destination. Prior to reaching the active destination, the instructions cause the one or more processors to provide at least a second set of navigation directions for navigating from a current location of the user to at least one of the alternative destinations.

### BRIEF DESCRIPTION OF THE DRAWINGS

FIG. 1 is a block diagram of an example communication system in which techniques for altering a destination during a navigation session can be implemented;

FIG. 2 illustrates an example geographic query from a user to the user computing device of FIG. 1;

FIG. 3 illustrates an example map display including an example route for traveling to a POI responsive to the request indicated in FIG. 2, where the POI is selected as an active destination and the other POIs responsive to the request are stored as alternative destinations;

FIG. 4 illustrates another example map display presented when the user misses a turn on the route to the active destination of FIG. 3 and an alternative route is provided for traveling to one of the alternative destinations;

FIG. 5 illustrates another example geographic query from a user to the user computing device of FIG. 1, and an example response to the geographic query indicating alternative sets of navigation directions to alternative destinations responsive to the geographic query;

FIG. 6 illustrates yet another example geographic query from a user to the user computing device of FIG. 1, and an example response to the geographic query which includes characteristics of each of the alternative destinations; and

FIG. 7 is a flow diagram of an example method for altering a destination during a navigation session, which can be implemented in a computing device, such as the server device of FIG. 1.

### DETAILED DESCRIPTION

### Overview

Generally speaking, the techniques of this disclosure include a user computing device, a vehicle computing device, and/or one or more network servers. However, for clarity, the examples below focus primarily on an embodiment in which a user computing device obtains a geographic query from the user for providing navigation directions to a particular type of POI. For example, the query may be for navigation directions to a gas station, a restaurant, a particular type of restaurant (e.g., a pizza restaurant, an Italian restaurant, a Mexican restaurant, etc.), a chain restaurant with several locations (e.g., McDonalds®), a parking lot, a grocery store, a movie theatre, a shopping mall, a department store, etc.

In any event, the user computing device provides the geographic query to a server device. The server device then identifies a set of POIs responsive to the geographic query as candidate destinations. The server device may rank the set of POIs based on the distance from the user's current location, the duration of the routes to each POI, reviews of the POIs, the cost of the goods or services provided by each POI, etc. Then the server device selects one of the POIs as an active destination for providing navigation directions. In some implementations, the server device may select the highest ranking POI as the active destination. In other implementations, the server device may provide the set of POIs to the user computing device for display to the user for the user to select one of the POIs as the active destination.

In any event, the server device then generates a first set of navigation directions for traveling along a first route from the user's current location to the active destination and provides the first set of navigation directions to the user computing device. Additionally, the server device may store the other POIs which were not selected as the active destination as alternative destinations. In other implementations, the server device may provide the alternative destination to the user computing device to store.

The user computing device may then initiate a navigation session and may provide turn-by-turn navigation directions to the active destination as the user travels along the route. During the navigation session, the user computing device may also provide turn-by-turn navigation directions to at least one of the alternative destinations.

For example, the server device may generate a second set of navigation directions for traveling along a second route from the user's current location to an alternative destination and may provide the second set of navigation directions to the user computing device. The user computing device may present the first and second routes to the active destination and the alternative destination, simultaneously, on a map display so that the user can see both routes to both destinations. Then as the user progresses along one of the routes and makes a turn inconsistent with the other route, the user computing device may filter out the destination corresponding to the other route, and may no longer provide navigation along the other route.

In other implementations, the user computing device first presents the first route to the active destination. Then if the user makes an incorrect turn or circumstances change, such that the second route to the alternative destination is faster, the user computing device may replace the first route with the second route. In these implementations, the user computing device presents the sets of navigation directions one at a time, so that the user views directions to one destination at a time. Then the user computing device provides the second set of navigation directions in response to setting the alternative destination as the new active destination.

For example, the user computing device may periodically or continuously transmit updated location data for the user to the server device. Based on the updated location data, the server device may determine updated distances or durations in the routes remaining to the active destination and to the alternative destination(s). If a route to an alternative destination is faster than the current route to the active destination, has a shorter distance, and/or is more efficient (e.g., in terms of fuel usage), the server device may provide the route to the alternative destination to the user computing device to replace the current route to the active destination. Additionally or alternatively, the user computing device may provide a user control for the user to select whether they want to be directed to the alternative destination.

In addition to directing the user, the server device may obtain characteristics of each destination, such as reviews of the quality of the destination, hours of operation for the destination, the cost of the goods or services provided by the destination, menu specials at the destination, products sold at the destination, etc. The server device may provide the characteristics of each destination to the user computing device. Then the user computing device may include the characteristics of each destination when providing navigation directions for the destination, so that the user can decide whether they want to proceed to the active destination or switch to one of the alternative destinations.

### Example Hardware and Software Components

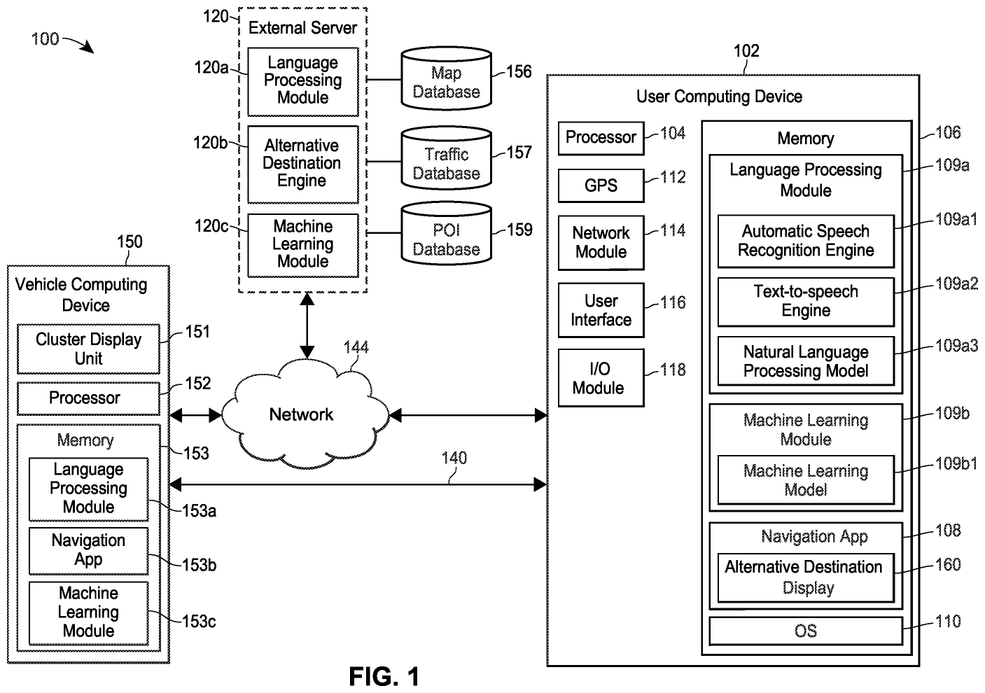

Referring first to FIG. 1, an example communication system 100 in which techniques for providing alternative destinations during a navigation session can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, a virtual reality headset, etc. In some embodiments, the user computing device 102 may be removably mounted in a vehicle, embedded into a vehicle, and/or may be capable of interacting with a head unit of a vehicle to provide navigation instructions. In other embodiments, the user computing device 102 is not within a vehicle environment.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc.

Further, the memory 106 may include a language processing module 109a configured to implement and/or support the techniques of this disclosure for determining places and routes through natural conversation. Namely, the language processing module 109a may include an automatic speech recognition (ASR) engine 109a1 that is configured to transcribe speech inputs from a user into sets of text. Further, the language processing module 109a may include a text-to-speech (TTS) engine 109a2 that is configured to convert text into audio outputs, such as audio requests, navigation instructions, and/or other outputs for the user. In some scenarios, the language processing module 109a may include a natural language processing (NLP) model 109a3 that is configured to output textual transcriptions, intent interpretations, and/or audio outputs related to a speech input received from a user of the user computing device 102. It should be understood that, as described herein, the ASR engine 109a1 and/or the TTS engine 109a2 may be included as part of the NLP model 109a3 in order to transcribe user speech inputs into a set of text, convert text outputs into audio outputs, and/or any other suitable function described herein as part of a conversation between the user computing device 102 and the user.

Generally, the language processing module 109a may include computer-executable instructions for training and operating the NLP model 109a3. In general, the language processing module 109a may train one or more NLP models 109a3 by establishing a network architecture, or topology, and adding layers that may be associated with one or more activation functions (e.g., a rectified linear unit, softmax, etc.), loss functions and/or optimization functions. Such training may generally be performed using a symbolic method, machine learning (ML) models, and/or any other suitable training method. More generally, the language processing module 109a may train the NLP models 109a3 to perform two techniques that enable the user computing device 102, and/or any other suitable device (e.g., vehicle computing device 151) to understand the words spoken by a user and/or words generated by a text-to-speech program (e.g., TTS engine 109a2) executed by the processor 104: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the NLP model 109a3 may generate textual transcriptions from the speech inputs from the user. Additionally, or alternatively, the NLP model 109a3 may receive such textual transcriptions as a set of text from the ASR engine 109a1 in order to perform semantic analysis on the set of text.

Semantic analysis generally involves analyzing text in order to understand and/or otherwise capture the meaning of the text. In particular, the NLP model 109a3 applying semantic analysis may study the meaning of each individual word contained in a textual transcription in a process known as lexical semantics. Using these individual meanings, the NLP model 109a3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP model 109a3 may generate one or more intent interpretations based on the textual transcriptions from the syntactic analysis.

In these aspects, the language processing module 109a may include an artificial intelligence (AI) trained conversational algorithm (e.g., the natural language processing (NLP) model 109a3) that is configured to interact with a user that is accessing the navigation application 108. The user may be directly connected to the navigation application 108 to provide verbal input/responses (e.g., speech inputs), and/or the user request may include textual inputs/responses that the TTS engine 109a2 (and/or other suitable engine/model/algorithm) may convert to audio inputs/responses for the NLP model 109a3 to interpret. When a user accesses the navigation application 108, the inputs/responses spoken by the user and/or generated by the TTS engine 109a2 (or other suitable algorithm) may be analyzed by the NLP model 109a3 to generate textual transcriptions and intent interpretations.

The language processing module 109a may train the one or more NLP models 109a3 to apply these and/or other NLP techniques using a plurality of training speech inputs from a plurality of users. As a result, the NLP model 109a3 may be configured to output textual transcriptions and intent interpretations corresponding to the textual transcriptions based on the syntactic analysis and semantic analysis of the user's speech inputs.

In certain aspects, one or more types of machine learning (ML) may be employed by the language processing module 109a to train the NLP model(s) 109a3. The ML may be employed by the ML module 109b, which may store a ML model 109b1. The ML model 109b1 may be configured to receive a set of text corresponding to a user input, and to output an intent and destination(s) based on the set of text. The NLP model(s) 109a3 may be and/or include one or more types of ML models, such as the ML model 109b1. More specifically, in these aspects, the NLP model 109a3 may be or include a machine learning model (e.g., a large language model (LLM)) trained by the ML module 109b using one or more training data sets of text in order to output one or more training intents and one or more training destinations, as described further herein. For example, artificial neural networks, recurrent neural networks, deep learning neural networks, a Bayesian model, and/or any other suitable ML model 109b1 may be used to train and/or otherwise implement the NLP model(s) 109a3. In these aspects, training may be performed by iteratively training the NLP model(s) 109a3 using labeled training samples (e.g., training user inputs).

In instances where the NLP model(s) 109a3 is an artificial neural network, training of the NLP model(s) 109a3 may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction.

In embodiments, the one or more NLP models 109a3 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

It is noted that although FIG. 1 illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and providing outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1 or, conversely, additional components.

The user computing device 102 may communicate with a server device 120 and/or a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content from a map database 156 to the vehicle computing device 150 for display on the cluster display unit 151. Additionally, or alternatively, the navigation application 108 may access map, navigation, and geo-located content that is stored locally at the user computing device 102, and may access the map database 156 periodically to update the local data or during navigation to access real-time information, such as real-time traffic data. Moreover, the user computing device 102 may be directly connected to the vehicle computing device 150 through any suitable direct communication link 140, such as a wired connection (e.g., a USB connection).

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The server device 120 may be a remotely located server that includes processing capabilities and executable instructions necessary to perform some/all of the actions described herein with respect to the user computing device 102. For example, the server device 120 may include a language processing module 120a that is similar to the language processing module 109a included as part of the user computing device 102, and the module 120a may include one or more of the ASR engine 109a1, the TTS engine 109a2, and/or the NLP model 109a3. Additionally, the server device 120 may include an alternative destination engine 120b which identifies POIs responsive to a geographic query, and provides navigation directions to an active destination and/or to one or more alternative destinations. The server device 120 may also include an ML module 120c that is similar to the ML module 109b included as part of the user computing device 102.

The vehicle computing device 150 includes one or more processor(s) 152 and a memory 153 storing computer-readable instructions executable by the processor(s) 152. The memory 153 may store a language processing module 153a, a navigation application 153b, and a ML module 153c that are similar to the language processing module 153a, the navigation application 108, and the ML module 109b, respectively. The navigation application 153b may support similar functionalities as the navigation application 108 from the vehicle-side and may facilitate rendering of information displays, as described herein. For example, in certain aspects, the user computing device 102 may provide the vehicle computing device 150 with an accepted route that has been accepted by a user, and the corresponding navigation instructions to be provided to the user as part of the accepted route. The navigation application 153b may then proceed to render the navigation instructions within the cluster unit display 151 and/or to generate audio outputs that verbally provide the user with the navigation instructions via the language processing module 153a.

In any event, the user computing device 102 may be communicatively coupled to various databases, such as a map database 156, a traffic database 157, and a POI database 159, from which the user computing device 102 can retrieve navigation-related data. The map database 156 may include map data such as map tiles, visual maps, road geometry data, road type data, speed limit data, etc. The map database 156 may also include route data for providing navigation directions, such as driving, walking, biking, or public transit directions, for example. The traffic database 157 may store historical traffic information as well as real-time traffic information. The POI database 159 may store descriptions, locations, images, and other information regarding landmarks, places, or other points-of-interest, such as restaurants, bars, parking lots, hotels, movie theatres, amusement parks, stadiums, concert venues, opera houses, casinos, museums, parks, bowling alleys, pool halls, pharmacies, grocery stores, banks, department stores, hardware stores, convenience stores, supermarkets, farmer's markets, gyms, swimming pools, tennis courts, waterparks, zoos, aquariums, etc. For example, POI database 159 may store metadata associated with each POI. The particular metadata stored depends on the POI. For example, a grocery store may include product or stock metadata that includes a list of all products stocked at that grocery store. As another example, a restaurant may include food type metadata indicating the type(s) of food, or even specific meals or specials, served at that restaurant. POI metadata may also include the location of the POI. Where relevant, POI metadata may also include opening and closing times, a description of the cost of the goods or services provided by the POI, reviews or ratings of the POI, reservation availability or any other data useful for distinguishing POIs of similar types from one another.

While FIG. 1 depicts databases 156, 157, and 159, the user computing device 102, the vehicle computing device 150, and/or the server device 120 may be communicatively coupled to additional, or conversely, fewer, databases. For example, the user computing device 102 and/or the vehicle computing device 150 may be communicatively coupled to a database storing weather data.

When the user provides a geographic query for navigating to a destination via the navigation application 108, the user computing device 102 may provide the geographic query to the server device 120. The user may provide a particular trigger phrase or hot word which causes the navigation application 108 to receive the audio request from the user, such as “Hey Maps.” The user may also provide a particular mode of transportation for the navigation directions, such as driving directions, walking directions, biking directions, public transportation directions, ridesharing directions, etc.

Additionally, the language processing module 109a, 120a at the user computing device 102 or the server device 120 may analyze the query to determine 1) the intent to receive navigation directions, and/or 2) the type of destination the user is requesting. For example, the language processing module 109a, 120a may determine that the query is for navigation directions if the query includes the phrase “navigate to,” “take me to,” “I want to go to,” etc. The language processing module 109a, 120a may also utilize the machine learning module 109b, 120c to determine whether a query is for navigation directions. For example, the machine learning module 109b, 120c may generate a machine learning model 109b1 trained using a first set of queries which are for navigation directions and a second set of queries which are not for navigation directions. The machine learning model 109b1 can include one or more tests for distinguishing whether a query is for navigation directions or not based on the training data. The language processing module 109a, 120a may apply the request to the machine learning model 109b1 to determine whether the query is for navigation directions.

To identify the type of destination requested in the query, the language processing module 109a, 120a may determine whether the query includes a specific destination with one location (e.g., Jim's Fish House on 123 Main Street) or is a more general query for a category of POIs, such as gas stations, restaurants, a chain restaurant with several locations, etc. A category of POIs may include a plurality of POIs of the same category. POIs of a same category may be POIs that offer the same service, such as gas stations, restaurants, hotels, etc. The category of each POI may be stored as a description or metadata of each POI in the POI database 159. For example, if the query includes terms like “nearest” or “closest,” the language processing module 109a, 120a may determine that the query is not for a particular POI but a category of POIs. Furthermore, if the query includes a qualifier after the POI, the language processing module 109a, 120a may determine that the query is for a particular POI, such as “take me to the Starbucks® by my house.”

In any event, the server device 120 obtains the intent to receive navigation directions and/or the type of destination included in the geographic query from the user computing device 102, or obtains the query from the user computing device 102 and determines the intent and/or type of destination from the query. Then the server device 120, and more specifically, the alternative destination engine 120b identifies a set of POIs responsive to the geographic query as candidate destinations by, for example, communicating with the POI database 159.

In some implementations, the alternative destination engine 120b identifies candidate POIs which are within a threshold radius of the user's current or starting location. The alternative destination engine 120b may then select one of the candidate POIs as an active destination for providing navigation directions.

In some implementations, to select one of the candidate POIs, the alternative destination engine 120b provides the set of candidate POIs to the user computing device 102 to display to the user. Then the user selects a candidate POI to be the active destination via a user control presented on a map display.

In other implementations, the alternative destination engine 120b ranks the set of candidate POIs and selects the highest ranking candidate POI as the active destination. For example, the alternative destination engine 120b may rank the set of candidate POIs according to distance or duration from the user's current location. The alternative destination engine 120b may also rank the set of candidate POIs according to the cost of the goods or services provided by the candidate POIs.

Moreover, the alternative destination engine 120b may rank the set of candidate POIs according to how closely they match the terms of the geographic query. For example, if the query is for “gas stations in Los Angeles” and a candidate POI is a gas station just outside the border of Los Angeles, the candidate POI may be ranked below candidate POIs directly in Los Angeles. In another example, if the query is for “fast food restaurants” and a candidate POI is a restaurant with reviews that say the food comes out quickly but the candidate POI is not categorized as fast food, the candidate POI may be ranked below candidate POIs categorized as fast food.

Still further, the alternative destination engine 120b may rank the candidate POIs according to their quality based on ratings or reviews of the POIs. However, these are just a few example criteria for ranking the candidate POIs. The alternative destination engine 120b may rank the candidate POIs based on any suitable combination of these criteria and/or any other criteria.

In any event, one of the candidate POIs is selected as an active destination, and the alternative destination engine 120b stores the remaining candidate POIs as alternative destinations. The remaining candidate POIs may be of a same category as the selected candidate POI. In other implementations, the alternative destination engine 120b stores a subset of the other candidate POIs in the set as alternative destinations, which can include one or more of the other candidate POIs. The other candidate POIs may also be of a same category as the selected candidate POI. For example, the alternative destination engine 120b stores one or more of the other candidate POIs in the set as alternative destinations when they are deemed to be equivalent to the active destination.

More specifically, the alternative destination engine 120b may identify other candidate POIs which are equivalent to the active destination when they have one or more of the same or similar characteristics as the active destination (e.g., the price range is within a threshold range of the active destination, the rating is the same or within a threshold rating of the active destination, a score or indicator of how closely the other candidate POI matches the geographic query is within a threshold range of a score of indicator of how closely the active destination matches the geographic query, etc.). For example, the alternative destination engine 120b may determine similarity by assigning scores to the characteristics (e.g., a price score, a review score, a query matching score, etc.). Then the alternative destination engine 120b may compare the scores for the active destination to the scores for the other candidate POI and determine whether the other candidate POI is equivalent to the active destination based on the difference in scores. For example, the alternative destination engine 120b may determine the Euclidean distance or the L1 distance (i.e., the sum of the absolute values of the differences in scores) between the scores for the active destination and the scores for the other candidate POI.

Then if the Euclidean distance or the L1 distance is less than a threshold number, the alternative destination engine 120b may determine that the other candidate POI is equivalent to the active destination.

In some implementations, the alternative destination engine 120b may also determine a confidence level for the candidate POIs indicating the degree to which each candidate POI is equivalent to the active destination. For example, the alternative destination engine 120b may assign a low confidence level to candidate POIs having a Euclidean distance or L1 distance which is less than a first threshold but greater than a second threshold number. The alternative destination engine 120b may assign a high confidence level to candidate POIs having a Euclidean distance or L1 distance which is less than the first threshold and less than the second threshold number.

Then the alternative destination engine 120b may provide the user's current location and the active destination to a map database 156 for example, for the map database 156 to generate a first route from the user's current location to the active destination. The alternative destination engine 120b may then provide the first set of navigation directions for the first route to the user computing device 102 for display to the user.

Additionally or alternatively, the alternative destination engine 120b may provide the user's current location and an alternative destination to the map database 156 for example, for the map database 156 to generate a second route from the user's current location to the alternative destination. The alternative destination engine 120b may then provide the second set of navigation directions for the second route to the user computing device 102 for display to the user.

In this manner, the user may view multiple sets of navigation directions for multiple destinations simultaneously, for example as the user travels along one of the routes during a navigation session. Moreover, the second set of navigation directions and/or other sets of navigation directions for additional alternative destinations are provided without additional input from the user. In other words, the user does not need to request navigation directions to a different destination. A request for directions to one destination results in receiving directions to multiple destinations. The alternative destination engine 120b may repeat this process for each of the alternative destinations or for a threshold number of alternative destinations. For example, the alternative destination engine 120 may provide sets of navigation directions for the top N ranked candidate POIs which are then presented by the user computing device 102. By presenting, by the user computing device 102, multiple sets of navigation directions for multiple destinations simultaneously, the user may quickly and easily switch destination without having to request navigation directions to a different destination. As a result, the destination may be changed more efficiently as the system doesn't need to generate the new route after selection. Further, the destination may be changed in a safer manner as user interaction to change the destination, while navigating, is reduced, simple and efficient.

For example, the alternative destination display 160 may present indications of each route to each destination and/or sets of navigation directions on the user interface 116 of the user computing device 102. In some implementations, the alternative destination display 160 may present indications of the active destination and the alternative destination(s) on a map display of the navigation application 108.

The alternative destination engine 120b may also obtain characteristics of the active destination and the alternative destination(s) from the POI database 159. These characteristics may include reviews or ratings of the quality of each destination, hours of operation for each destination, the cost of the goods or services provided by each destination, menu specials at each destination, products sold at each destination, etc. The characteristics may be selected based on the type of POI for each destination. For example, for a restaurant the characteristics may include reviews or ratings of the restaurant, whereas for a parking lot the characteristics may include the cost to park in the lot.

The alternative destination engine 120b may provide the characteristics of each destination to the user computing device 102 with the navigation directions to each destination. Then the user computing device 102 may include the characteristics of each destination when providing navigation directions for the destination, so that the user can decide whether they want to proceed to the active destination or switch to one of the alternative destinations.

For example, the alternative destination display 160 may present an audio announcement via the speakers 118 of the user computing device 102 indicating that the active destination is fine dining and is expensive while the alternative destination is a casual, inexpensive restaurant. The alternative destination display 160 may present the audio announcement before providing sets of audio navigation instructions to each of the destinations. In other implementations, the alternative destination display 160 may present the audio announcement while providing sets of audio navigation instructions to each of the destinations. For example, the alternative destination display 160 may explain, “Turn left to go to Bill's Dining Establishment. This is a fine dining restaurant serving expensive dishes. Turn right to go to Dave's Fish Fry-a casual, inexpensive eatery.”

In other implementations, the alternative destination engine 120b does not provide the second route to the alternative destination to the user computing device 102. Instead, as the user progresses on the first route to the active destination, the alternative destination engine 120b periodically or continuously obtains an updated location from the user computing device 102. The alternative destination engine 120b may then periodically or continuously obtain distances or durations remaining from the user's updated location to the active destination and the alternative destinations.

If the distance and/or duration remaining for arriving at an alternative destination is less than the distance and/or duration remaining for arriving at the active destination (e.g., due to the user missing a turn, changed circumstances such as increased traffic on the first route, etc.), then the alternative destination engine 120b may obtain the second route from the user's updated location to the alternative destination from the map database 156. In other implementations, the alternative destination engine 120b obtains the second route when the distance and/or duration remaining for arriving at the active destination exceeds the distance and/or duration remaining for arriving at the alternative destination by more than a threshold amount (e.g., 5 minutes). In this manner, the user computing device 102 does not constantly change destinations.

In any event, the alternative destination engine 120b may provide the second route for traveling to the alternative destination to the user computing device 102. The user computing device 102 may either replace the first route with the second route and change the active destination to the alternative destination, or may provide the user with the option of whether or not to switch destinations. As such, the navigation system beneficially provides, in response to a user failing to follow the first route to the active destination, the second route to the alternative destination of the same category which is now a more efficient route than travelling to the original destination in terms of distance, time, fuel or another metric.

For example, the user computing device 102 may replace the first route with the second route and change the active destination to the alternative destination when the equivalency confidence level for the alternative destination is high. Then the alternative destination display 160 may present an announcement that there is a similar destination which is closer to the user, and may provide the name and/or a description of the destination. The announcement may also indicate that the active destination is being changed since it is faster to reach the alternative destination, but that the user can follow the first route if they would like to reach the original destination. For example, the announcement may be, “Navigating to the Fast Gas on El Camino Real since it's faster. Follow the alternate route if you want to reach your original destination.

On the other hand, the user computing device 102 may provide the user with the option of whether or not to switch destinations, for example when the equivalency confidence level for the alternative destination is low. Then the alternative destination display 160 may present an announcement that there is a similar destination which is closer to the user, and may provide the name and/or a description of the destination. The alternative destination display 160 may ask the user if they would like to switch to the alternative destination. For example, the announcement may be, “I'd suggest navigating to the Fast Gas on El Camino Real as it will be 2 minutes faster. Is that ok?”

If the user indicates that they would like to switch destinations, the alternative destination display 160 may set the alternative destination as the active destination. Then the alternative destination display 160 may present an indication of the second route on the map display and may remove the first route from the map display. If the user indicates that they would not like to switch destinations, the alternative destination display 160 continues to present an indication of the first route to the active destination on the map display. The alternative destination display 160 may also present an indication of the second route to the alternative destination as an alternative route.

### Example Requests for Goal-Oriented Navigation Instructions

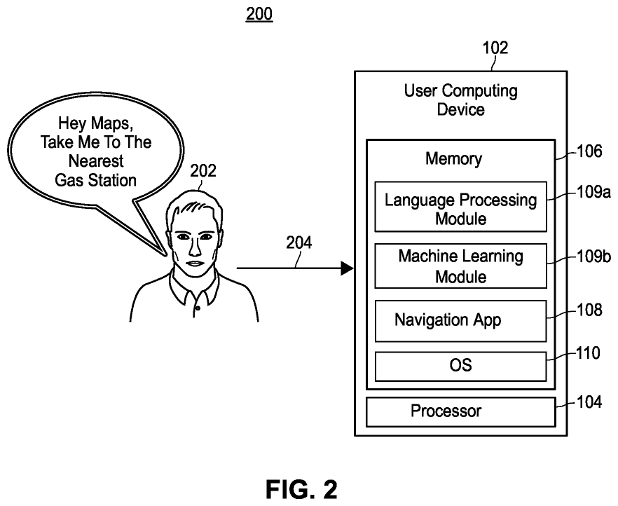

The techniques of this disclosure for altering a destination during a navigation session are discussed below with reference to the conversation flows and map displays illustrated in FIGS. 2-6. Throughout the description of FIGS. 2-6, actions described as being performed by the user computing device 102 may, in some implementations, be performed by the server device 120, the vehicle computing device 150, and/or may be performed by the user computing device 102, the server device 120, and/or the vehicle computing device 150 in parallel. For example, the user computing device 102, the server device 120, and/or the vehicle computing device 150 may utilize the language processing module 109a, 120a, 153a and/or the machine learning module 109b, 120c, 153c to identify active and alternative destinations and provide navigation directions to the active and alternative destinations.

While the example scenarios in FIGS. 2-6 include queries related to driving directions these are merely a few examples for ease of illustration only. The navigation system can be used for any suitable mode of transportation including driving, walking, biking, or public transportation.

Moreover, while the example scenarios in FIGS. 2-6 include an active destination and one alternative destination, these are merely a few example for ease of illustration only. The navigation system may present visual and/or audio navigation instructions for any suitable number of alternative destinations.

Additionally, while the example scenarios described herein are generally in the context of a speech based configuration, the navigation system can also be used in the context of a touch-based or visual interface. For example, geographic search queries can be entered via free-form textual input or through UI elements (e.g. a drop-down menu). Responses to the geographic search queries can be displayed to the user via the user interface. Embodiments disclosed herein that are described in the context of a speech-based interface may also be applied to the context of a touch-based interface. All embodiments disclosed herein in which inputs or outputs are described in the context of a speech-based interface may be adapted to apply to the context of a touch-based interface.

FIG. 2 illustrates an example scenario 200 where the user 202 provides a geographic query to the user computing device 102. More specifically, the user 202 states 204, “Hey Maps, take me to the nearest gas station.”

The language processing module 109a, 120a at the user computing device 102 and/or the server device 120 may then analyze the user's query to determine the intent is to receive navigation directions and the type of destination is a gas station.

The server device 120 obtains a set of candidate POIs from the POI database 159 which are gas stations. For example, POIs having the category “gas station” are obtained. In some implementations, the server device 120 identifies candidate POIs which are within a threshold radius of the user's current location and/or within the same geographic area as the user's current location (e.g., the same city, state, country, etc.).

For example, the server device 120 may identify five gas stations within the threshold radius of the user's current location. Then the server device 120 may select one of the candidate POIs as an active destination. For example, the server device 120 may rank the candidate POIs in the manner described above and may provide the ranked set of candidate POIs to the user computing device 102 for display to the user. Then the user may select one of the candidate POIs as the active destination. In other implementations, the server device 120 may automatically select the highest ranking candidate POI as the active destination. In any event, the user may select a user control on the map display to initiate a navigation session and receive turn-by-turn navigation directions as the user travels along a route to the active destination.

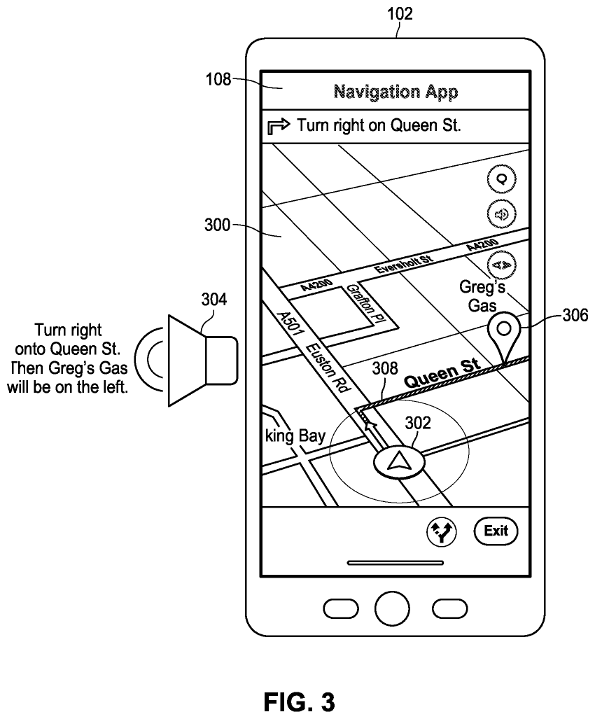

Then the user computing device 102 may present an indication of the first route to the active destination on the map display and provide turn-by-turn navigation directions. FIG. 3 illustrates an example map display 300 which may be presented, via the navigation application 108, on the user interface 116 of the user computing device 102.

The map display 300 includes an indication of the user's current location 302, an indication of the active destination 306 (Greg's Gas), and an indication of the first route 308 for traveling to the active destination 306.

In some implementations, the user computing device 102 may also present a first set of audio navigation instructions via the speakers 118 for navigating to the active destination 304.

The user computing device 102 may generate the text of the audio navigation instructions 304 by utilizing the language processing module 109a, and in certain aspects, a large language model (LLM) (e.g., language model for dialogue applications (LaMDA)) (not shown) included as part of the language processing module 109a. Such an LLM may be conditioned/trained to generate the audio navigation text.

In any event, when the user computing device 102 fully generates the text of the audio navigation instructions 304, the user computing device 102 may proceed to synthesize the text into speech for audio output to the user. In particular, the user computing device 102 may transmit the text of the audio navigation instructions 304 to a TTS engine (e.g., TTS engine 109a2) in order to audibly output the audio navigation instructions 304 through a speaker 118, so that the user may hear and interpret the audio navigation instructions 304.

Specifically, the audio navigation instructions 304 are to turn right onto Queen Street and Greg's Gas will be on the left. If the user misses the turn, the user computing device 102 may transmit an updated location of the user to the server device 120. The server device may then determine updated durations and/or distances to the candidate destinations and may re-rank the candidate destinations based on the updated durations and/or distances. For example, Gas ‘n’ Save may be ranked ahead of Greg's Gas in the new rankings because the user would have to turn around to navigate to Greg's Gas. Accordingly, the route to Gas ‘n’ Save is now shorter than the route to Greg's Gas.

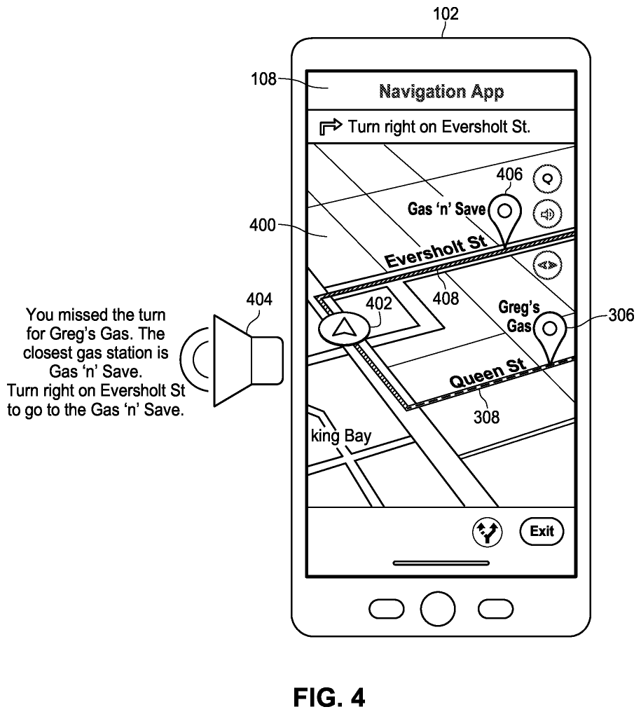

As a result, the server device 120 may provide a second set of navigation directions to the user computing device 102 for a second route to the alternative destination, Gas ‘n’ Save. FIG. 4 illustrates an example map display 400 which may be presented, via the navigation application 108, on the user interface 116 of the user computing device 102.

The map display 400 includes an indication of the user's updated current location 402 after the user missed the turn onto Queen St. The map display 400 also includes an indication of the alternative destination 406 (Gas ‘n’ Save), and an indication of the second route 408 for traveling to the alternative destination 406. In this example scenario, the alternative destination 406 may take over as the new active destination, and the active destination 306 may be the former active destination.

In addition to presenting the second route, the map display 400 may continue to present an indication of the first route to the former active destination 306 as an alternative route. The first and second routes may be highlighted in different colors or with different markings to denote that the second route is for the new active destination, and the first route is for the former active destination and is now an alternative route.

In some implementations, the user computing device 102 may also present a second set of audio navigation instructions 404 via the speakers 118 for navigating to the new active destination 406. Specifically, the audio navigation instructions 404 are to turn right on Eversholt St to go to Gas ‘n’ Save. The audio navigation instructions 404 also include an audio announcement that the user missed the turn for Greg's Gas and Gas ‘n’ Save is the closest gas station.

In other implementations, the map display 400 may no longer present an indication of the former active destination 306 or the first route to the former active destination 306. Instead, the map display 400 may present an indication of single route 408 to the new active destination 406.

In some implementations, the audio announcement may provide the user with the option of whether to make the alternative destination 406 the new active destination or to continue providing navigation directions to Greg's Gas 306. Then if the user decides to continue navigating to Greg's Gas 306, the map display 400 may present the second route to Gas ‘n’ Save 406 as an alternative route, but may provide turn-by-turn audio navigation instructions to Greg's Gas 306.

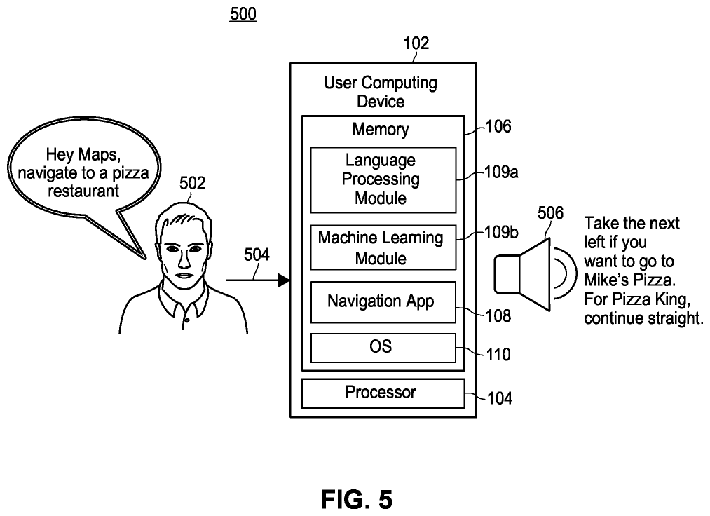

FIG. 5 illustrates an example scenario 500 where the user 502 provides a geographic query to the user computing device 102. More specifically, the user 502 states 504, “Hey Maps, navigate to a pizza restaurant.”

The language processing module 109a, 120a at the user computing device 102 and/or the server device 120 may then analyze the user's query to determine the intent is to receive navigation directions and the type of destination is a pizza restaurant.

The server device 120 obtains a set of candidate POIs from the POI database 159 which are pizza restaurants. For example, POIs having the category “pizza restaurant” are obtained. In some implementations, the server device 120 identifies candidate POIs which are within a threshold radius of the user's current location and/or within the same geographic area as the user's current location (e.g., the same city, state, country, etc.).

For example, the server device 120 may identify two pizza restaurants within the threshold radius of the user's current location. Then the server device 120 may select one of the candidate POIs as an active destination. For example, the server device 120 may rank the candidate POIs in the manner described above and may provide the ranked set of candidate POIs to the user computing device 102 for display to the user. Then the user may select one of the candidate POIs as the active destination. In other implementations, the server device 120 may automatically select the highest ranking candidate POI as the active destination. In any event, the user may select a user control on the map display to initiate a navigation session and receive turn-by-turn navigation directions as the user travels along a route to the active destination.

Then the user computing device 102 may present a first set of audio navigation instructions via the speakers 118 for navigating to the active destination (Mike's Pizza). In addition to presenting the first set of audio navigation instructions, the user computing device 102 may simultaneously present a second set of audio navigation instructions via the speakers 118 for navigating to an alternative destination (Pizza King). For example, the first and second set of audio navigation instructions 506 may be “Take the next left if you want to go to Mike's Pizza. For Pizza King, continue straight.” In this manner, the user may choose their destination by navigating in the direction of the chosen destination.

Then the user computing device 102 may identify maneuvers in the first and second set of navigation directions from the same waypoint that result in the user traveling in different directions. Here, the maneuvers are to turn left or continue straight. As the user approaches the waypoint, the user computing device 102 may determine whether the user performs a first maneuver corresponding to the first set of navigation directions (by turning left) or performs a second maneuver corresponding to the second set of navigation directions (by continuing straight).

If the user performs the first maneuver (by turning left), the user computing device 102 may filter the alternative destination (Pizza King) from the alternative destinations and may no longer provide the second set of navigation directions for the remaining portion of the second route.

If the user performs the second maneuver (by continuing straight), the user computing device 102 may set the alternative destination (Pizza King) as the new active destination and may no longer provide the first set of navigation directions for the remaining portion of the first route. By no longer providing the set of navigation directions which now relates to a less efficient route to reach a POI of a certain category, the presentation of navigation directions is clearer. Further, in the case that navigation directions are displayed on the user computing device 102, only providing the more efficient route improves the use of display space on the user computing device 102.

In addition to providing navigation directions, the user computing device 102 may provide the user with information about the active destination and/or the alternative destination(s). In this manner, the user may be able to make an informed decision about the destination to select based on the characteristics of the destinations.

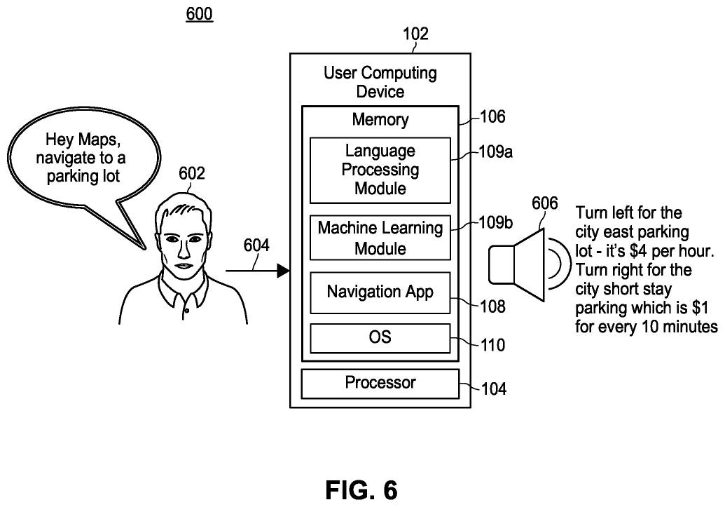

FIG. 6 illustrates an example scenario 600 where the user 602 provides a geographic query to the user computing device 102. More specifically, the user 602 states 604, “Hey Maps, navigate to a parking lot.”

The language processing module 109a, 120a at the user computing device 102 and/or the server device 120 may then analyze the user's query to determine the intent is to receive navigation directions and the type of destination is a parking lot.

The server device 120 obtains a set of candidate POIs from the POI database 159 which are parking lots. For example, POIs having the category “parking lot” are obtained. In some implementations, the server device 120 identifies candidate POIs which are within a threshold radius of the user's current location and/or within the same geographic area as the user's current location (e.g., the same city, state, country, etc.).

For example, the server device 120 may identify two parking lots within the threshold radius of the user's current location. Then the server device 120 may select one of the candidate POIs as an active destination. For example, the server device 120 may rank the candidate POIs in the manner described above and may provide the ranked set of candidate POIs to the user computing device 102 for display to the user. Then the user may select one of the candidate POIs as the active destination. In other implementations, the server device 120 may automatically select the highest ranking candidate POI as the active destination. In any event, the user may select a user control on the map display to initiate a navigation session and receive turn-by-turn navigation directions as the user travels along a route to the active destination.

Additionally, the server device 120 may obtain characteristics of each of the parking lots for example, from the POI database 159. The characteristics may include reviews of the parking lots, hours of operation for the parking lots, the cost to park at each parking lot, etc. The server device 120 may provide the characteristics to the user computing device 102.

Then the user computing device 102 may present a first set of audio navigation instructions via the speakers 118 for navigating to the active destination (the city east parking lot). The user computing device 102 may also present a description of the obtained characteristics for the active destination. In addition to presenting the first set of audio navigation instructions, the user computing device 102 may simultaneously present a second set of audio navigation instructions via the speakers 118 for navigating to an alternative destination (city short stay parking). The user computing device 102 may also present a description of the obtained characteristics for the alternative destination. For example, the first and second set of audio navigation instructions with the obtained characteristics 606 may be “Turn left for the city east parking lot-it's $4 per hour. Turn right for the city short stay parking which is $1 for every 10 minutes.”

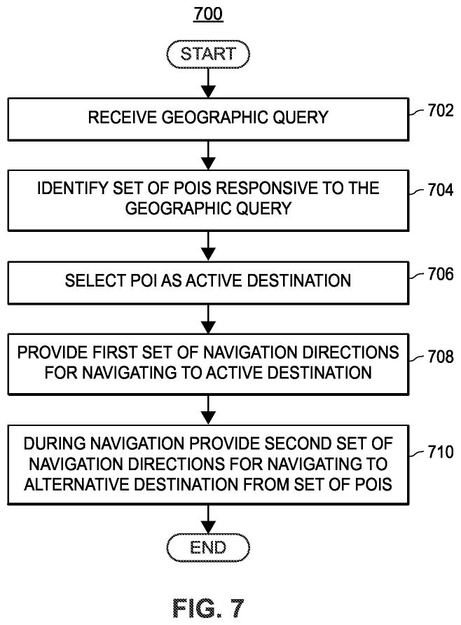

FIG. 7 is a flow diagram of an example method 700 for altering a destination during a navigation session, which can be implemented in the server device 120. More specifically, the method 700 can be implemented in a set of instructions stored on a computer-readable memory and executable at one or more processors of the server device 120.

It is to be understood that, throughout the description of FIG. 7, actions described as being performed by the server device 120 may, in some implementations, be performed by the user computing device 102, the vehicle computing device 150, and/or may be performed by the user computing device 102, the server device 120, and/or the vehicle computing device 150 in parallel. For example, the user computing device 102, the server device 120, and/or the vehicle computing device 150 may utilize the language processing module 109a, 120a, 153a and/or the machine learning module 109b, 120c, 153c to provide navigation directions to alternative destinations.

At block 702, the server device 120 receives a geographic query. For example, the query may be for navigation directions to a gas station, a restaurant, a particular type of restaurant (e.g., a pizza restaurant, an Italian restaurant, a Mexican restaurant, etc.), a chain restaurant with several locations (e.g., McDonalds®), a parking lot, a grocery store, a movie theatre, a shopping mall, a department store, etc.

The server device 120 identifies a set of candidate POIs responsive to the geographic query as candidate destinations by, for example, communicating with the POI database 159 (block 704). The server device 120 may identify a POI category based on the geographic query, and the set of candidate POIs may be POIs in the POI database 159 having the identified category. In some implementations, the server device 120 identifies candidate POIs which are within a threshold radius of the user's current or starting location.

Then the server device 120 selects one of the candidate POIs as an active destination (block 706) and stores the remaining candidate POIs as alternative destinations. In some implementations, to select one of the candidate POIs, the server device 120 provides the set of candidate POIs to the user computing device 102 to display to the user. Then the user selects a candidate POI to be the active destination via a user control presented on a map display.

In other implementations, the server device 120 ranks the set of candidate POIs and selects the highest ranking candidate POI as the active destination. For example, the server device 120 may rank the set of candidate POIs according to distance or duration from the user's current location. The server device 120 may also rank the set of candidate POIs according to the cost of the goods or services provided by the candidate POIs. Moreover, the server device 120 may rank the set of candidate POIs according to how closely they match the terms of the geographic query. Still further, the server device 120 may rank the candidate POIs according to their quality based on ratings or reviews of the POIs. However, these are just a few example criteria for ranking the candidate POIs. The server device 120 may rank the candidate POIs based on any suitable combination of these criteria and/or any other criteria.

In any event, the user may select a user control on a map display of the user computing device 102 to initiate a navigation session and receive turn-by-turn navigation directions as the user travels along a route to the active destination. During the navigation session as the user begins traveling, the server device 120 provides a first set of navigation directions for navigating along a first route to the active destination (block 708).

As the user travels to the active destination and prior to reaching the active destination, the server device 120 provides a second set of navigation directions for navigating along a second route to one of the alternative destinations (block 710). The server device 120 may also provide a third set of navigation directions for navigating along a third route to a second alternative destination, a fourth set of navigation directions for navigating along a fourth route to a third alternative destination, etc. For example, the user computing device 102 may present multiple sets of navigation directions for multiple destinations, simultaneously, as the user travels along the first route to the active destination. The user computing device 102 may also present indications of the active destination and each of the alternative destinations on the map display. Then as the user performs a maneuver which is inconsistent with one of the routes, the user computing device 102 filters out the destination corresponding to the route and may no longer provide navigation along that route. As previously mentioned, by no longer providing sets of navigation directions which now relate to less efficient routes to reach a POI of a certain category, the presentation of navigation directions is clearer. Further, in the case that navigation directions are displayed on the user computing device 102, only providing the more or most efficient route(s) improves the use of display space on the user computing device 102.

In another example, the user computing device 102 presents the first set of navigation directions for navigating along the first route to the active destination. Instead, as the user progresses on the first route to the active destination, the server device 120 periodically or continuously obtains an updated location from the user computing device 102. The server device 120 may then periodically or continuously obtain distances or durations remaining from the user's updated location to the active destination and the alternative destinations.

If the distance and/or duration remaining for arriving at an alternative destination is less than the distance and/or duration remaining for arriving at the active destination (e.g., due to the user missing a turn, changed circumstances such as increased traffic on the first route, etc.), then the server device 120 may obtain the second route from the user's updated location to the alternative destination from the map database 156.

Then the server device 120 may provide the second route for traveling to the alternative destination to the user computing device 102. The user computing device 102 may either replace the first route with the second route and change the active destination to the alternative destination, or may provide the user with the option of whether or not to switch destinations. As previously mentioned, the navigation system thus beneficially determines, in response to a user failing to follow the first route to the active destination of a certain category, the second route to the alternative destination of the same category which is now more efficient than travelling to the previous active destination in terms of distance, time, fuel or another metric.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 700 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The method 700 may be included as part of any backend server (e.g., a map data server, a server device, or any other type of server computing device, as described herein), client computing device modules of the example environment, for example, or as part of a module that is external to such an environment. Though the figures may be described with reference to the other figures for ease of explanation, the method 700 can be utilized with other objects and user interfaces. Furthermore, although the explanation above describes steps of the method 700 being performed by specific devices (such as a server device), this is done for illustration purposes only. The blocks of the method 700 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for providing navigation directions for alternative destinations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for altering a destination during a navigation session, the method comprising:
receiving, at one or more processors, a geographic query;
identifying, by the one or more processors, a set of points of interest (POIs) responsive to the geographic query, wherein one of the set of POIs is selected as an active destination for a user;
storing, by the one or more processors, one or more other POIs in the set as alternative destinations; and
during a navigation session as a user begins traveling:
providing, by the one or more processors, a first set of navigation directions for navigating to the active destination; and
prior to reaching the active destination, providing, by the one or more processors, at least a second set of navigation directions for navigating from a current location of the user to at least one of the alternative destinations.

2. The method of claim 1, wherein the active destination is a first active destination, and further comprising:
as the user travels on a first route to the first active destination:
determining, by the one or more processors, a duration or distance remaining in the first route to the first active destination; and
determining, by the one or more processors, a duration or distance of a second route to the alternative destination,
wherein providing the second set of navigation directions for navigating to the alternative destination includes:
in response to determining that the duration or distance remaining in the first route exceeds the duration or distance of the second route, setting the alternative destination as a second active destination; and
providing, by the one or more processors, the second set of navigation directions for navigating along the second route to the second active destination.

3. The method of claim 1, wherein the first set of navigation directions for navigating to the active destination and the second set of navigation directions for navigating to the at least one alternative destination are provided simultaneously, such that the second set of navigation directions are provided as an alternative set of navigation directions.

4. The method of claim 3, further comprising:
identifying, by the one or more processors, maneuvers in the first and second set of navigation directions from a same waypoint that result in the user traveling in different directions;
as the user approaches the waypoint, determining, by the one or more processors, whether the user performs a first maneuver corresponding to the first set of navigation directions or a second maneuver corresponding to the second set of navigation directions.

5. The method of claim 4, further comprising:
in response to determining that the user performed the first maneuver:
filtering, by the one or more processors, the alternative destination from the alternative destinations; and
no longer providing, the one or more processors, the second set of navigation directions for a remaining portion of the second route.

6. The method of claim 4, further comprising:
in response to determining that the user performed the second maneuver:
setting, by the one or more processors, the alternative destination as the active destination; and
no longer providing, the one or more processors, the first set of navigation directions for a remaining portion of the first route.

7. The method of claim 1, wherein the first set of navigation directions for navigating to the active destination and the second set of navigation directions for navigating to the at least one alternative destination are provided one at a time, such that the second set of navigation directions are provided in response to setting the at least one alternative destination as the active destination.

8. The method of claim 1, wherein the second set of navigation directions are provided without additional input from the user.

9. A computing device for altering a destination during a navigation session, the computing device comprising:
one or more processors; and
a non-transitory computer-readable memory coupled to the one or more processors and storing instructions thereon that, when executed by the one or more processors, cause the computing device to:
receive a geographic query;
identify a set of points of interest (POIs) responsive to the geographic query, wherein one of the set of POIs is selected as an active destination for a user;
store one or more other POIs in the set as alternative destinations; and
during a navigation session as a user begins traveling:
provide a first set of navigation directions for navigating to the active destination; and
prior to reaching the active destination, provide at least a second set of navigation directions for navigating from a current location of the user to at least one of the alternative destinations.

10. The computing device of claim 9, wherein the active destination is a first active destination, and the instructions further cause the computing device to:
as the user travels on a first route to the first active destination:
determine a duration or distance remaining in the first route to the first active destination; and
determine a duration or distance of a second route to the alternative destination, wherein to provide the second set of navigation directions for navigating to the alternative destination, the instructions cause the computing device to:
in response to determining that the duration or distance remaining in the first route exceeds the duration or distance of the second route, set the alternative destination as a second active destination; and
provide the second set of navigation directions for navigating along the second route to the second active destination.

11. The computing device of claim 9, wherein the first set of navigation directions for navigating to the active destination and the second set of navigation directions for navigating to the at least one alternative destination are provided simultaneously, such that the second set of navigation directions are provided as an alternative set of navigation directions.

12. The computing device of claim 11, wherein the instructions further cause the computing device to:
identify maneuvers in the first and second set of navigation directions from a same waypoint that result in the user traveling in different directions;
as the user approaches the waypoint, determine whether the user performs a first maneuver corresponding to the first set of navigation directions or a second maneuver corresponding to the second set of navigation directions.

13. The computing device of claim 12, wherein the instructions further cause the computing device to:
in response to determining that the user performed the first maneuver:
filter the alternative destination from the alternative destinations; and
no longer provide the second set of navigation directions for a remaining portion of the second route.

14. The computing device of claim 13, wherein the instructions further cause the computing device to:
in response to determining that the user performed the second maneuver:
set the alternative destination as the active destination; and
no longer provide the first set of navigation directions for a remaining portion of the first route.

15. The computing device of claim 9, wherein the first set of navigation directions for navigating to the active destination and the second set of navigation directions for navigating to the at least one alternative destination are provided one at a time, such that the second set of navigation directions are provided in response to setting the at least one alternative destination as the active destination.

16. The computing device of claim 9, wherein the second set of navigation directions are provided without additional input from the user.

17. A non-transitory computer-readable medium storing instructions thereon, that when executed by one or more processors cause the one or more processors to:
receive a geographic query;
identify a set of points of interest (POIs) responsive to the geographic query, wherein one of the set of POIs is selected as an active destination for a user;
store one or more other POIs in the set as alternative destinations; and
during a navigation session as a user begins traveling:
provide a first set of navigation directions for navigating to the active destination; and
prior to reaching the active destination, provide at least a second set of navigation directions for navigating from a current location of the user to at least one of the alternative destinations.

18. The computer-readable medium of claim 17, wherein the active destination is a first active destination, and the instructions further cause the one or more processors to:
as the user travels on a first route to the first active destination:
determine a duration or distance remaining in the first route to the first active destination; and
determine a duration or distance of a second route to the alternative destination, wherein to provide the second set of navigation directions for navigating to the alternative destination, the instructions cause the computing device to:
in response to determining that the duration or distance remaining in the first route exceeds the duration or distance of the second route, set the alternative destination as a second active destination; and
provide the second set of navigation directions for navigating along the second route to the second active destination.

19. The computer-readable medium of claim 17, wherein the first set of navigation directions for navigating to the active destination and the second set of navigation directions for navigating to the at least one alternative destination are provided simultaneously, such that the second set of navigation directions are provided as an alternative set of navigation directions.

20. The computer-readable medium of claim 19, wherein the instructions further cause the one or more processors to:
identify maneuvers in the first and second set of navigation directions from a same waypoint that result in the user traveling in different directions;
as the user approaches the waypoint, determine whether the user performs a first maneuver corresponding to the first set of navigation directions or a second maneuver corresponding to the second set of navigation directions.
